(19) United States
(12) Patent Application Publication
(10) Pub. No.: US 2015/0120383 A1
(43) Pub. Date: Apr. 30, 2015

(54) OPTIMIZING A BUSINESS PERFORMANCE FORECAST

(71) Applicant: International Business Machines Corporation, Armonk, NY (US)

(72) Inventors: ALBERT D. BENNAH, CARY, NC (US); WILLIAM J. PIAZZA, HOLLY SPRINGS, NC (US)

(73) Assignee: International Business Machines Corporation, Armonk, NY (US)

(21) Appl. No.: 14/063,427

(22) Filed: Oct. 25, 2013

Related U.S. Application Data
(63) Continuation of application No. 14/062,600, filed on Oct. 24, 2013.

(51) Int. Cl. G06Q 30/02

(52) U.S. Cl. CPC G06Q 30/0202
USPC 705/7.31

(57) ABSTRACT

Optimizing a business performance forecast includes: projecting, based on a projection algorithm, a performance forecast for a period of time, the projection algorithm including inputs having a weight and the projection algorithm associated with a confidence score; capturing results of actual performance for the period of time; comparing the results to the performance forecast, including determining whether the difference between the results and the forecast is less than a threshold; if the difference is less than the threshold, increasing the confidence score associated with the projection algorithm; if the difference is not less than the threshold: iteratively, until a difference between the results and a new forecast is less than the threshold: modifying the projection algorithm; projecting a new forecast based on the modified projection algorithm; and determining whether the difference between the results of actual performance and the new forecast is less than the predetermined threshold.

### CROSS-REFERENCE TO RELATED APPLICATION

This application is a continuation application of and claims priority from U.S. patent application Ser. No. 14/062,600, filed on Oct. 24, 2013.

### BACKGROUND OF THE INVENTION

1. Field of the Invention

The field of the invention is data processing, or, more specifically, methods, apparatus, and products for optimizing a business performance forecast.

2. Description of Related Art

Businesses today often utilize analytics software to generate a forecast of future sales. Most of that software generally relies on prior sales figures as well as upcoming events like holidays, weekends, and the like to generate a forecast. There are, however, many other factors that can influence sales that are not taken into account by the prior art analytics software in generating a sales forecast.

### SUMMARY OF THE INVENTION

Methods, apparatus, and products for optimizing a business performance forecast are disclosed in this specification. Optimizing a business performance forecast may include: projecting, by a projection module based on a projection algorithm, a performance forecast for a period of time, wherein the projection algorithm includes a plurality of inputs with each input having a weight and the projection algorithm is associated with a confidence score; capturing, by the projection module, results of actual performance for the period of time; comparing, by the projection module, the results of actual performance to the performance forecast, including determining whether the difference between the results of actual performance and the performance forecast is less than a predetermined threshold; if the difference between the results and the performance forecast is less than the predetermined threshold, increasing, by the projection module, the confidence score associated with the projection algorithm; if the difference between the results and the performance forecast is not less than the predetermined threshold: iteratively, until a difference between the results of actual performance and a new forecast is less than the predetermined threshold: modifying, by the projection module, the projection algorithm; projecting, by the projection module, a new forecast based on the modified projection algorithm; and determining, by the projection module, whether the difference between the results of actual performance and the new forecast is less than the predetermined threshold.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for optimizing a business performance forecast according to embodiments of the present invention.

FIG. 2 sets forth a flow chart illustrating an exemplary method for optimizing a business performance forecast according to embodiments of the present invention.

FIG. 3 sets forth a flow chart illustrating another exemplary method for optimizing a business performance forecast according to embodiments of the present invention.

FIG. 4 sets forth a flow chart illustrating another exemplary method for optimizing a business performance forecast according to embodiments of the present invention.

### DETAILED DESCRIPTION OF EXEMPLARY EMBODIMENTS

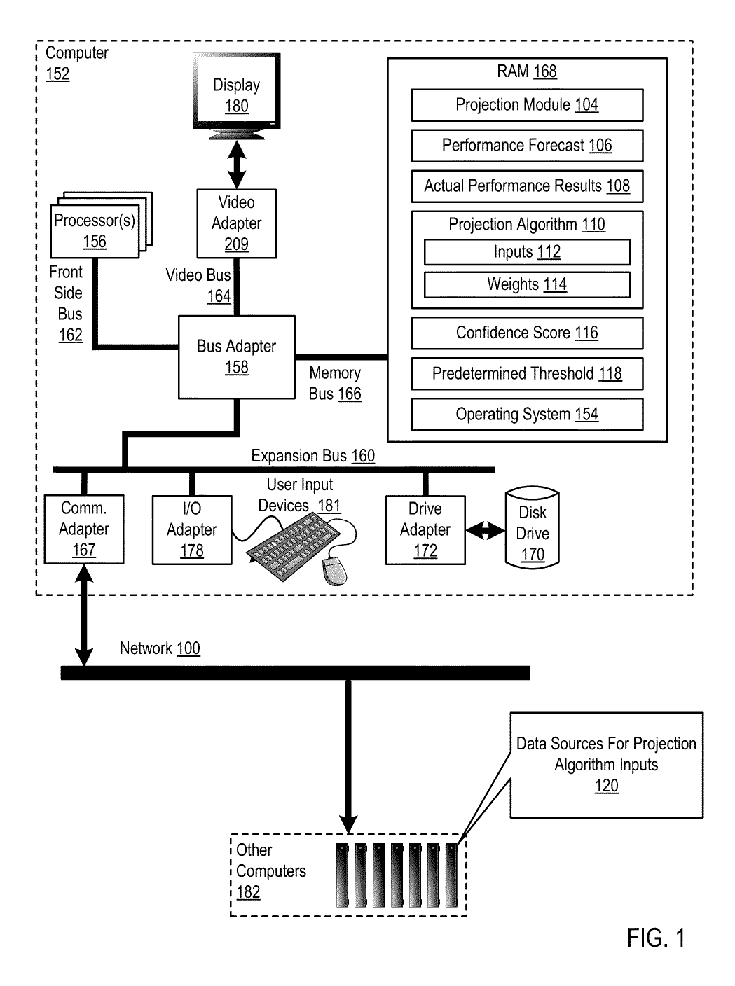

Exemplary methods, apparatus, and products for optimizing a business performance forecast in accordance with the present invention are described with reference to the accompanying drawings, beginning with FIG. 1. FIG. 1 sets forth a network diagram of a system for optimizing a business performance forecast according to embodiments of the present invention. The term ‘forecast’ refers to a prediction or estimate of future performance. Businesses utilize performance forecasts for various reasons such as supply chain management, investor guidance, determining workforce requirements, and others. Increasing the accuracy of such forecasts enables a business to rely more heavily on the forecasts.

The system of FIG. 1 includes an example of automated computing machinery in the form of a computer (152) useful in optimizing a business performance forecast according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is a projection module (104), a module of computer program instructions that, when executed, cause the computer (152) of FIG. 1 to optimize a business performance forecast in accordance with embodiments of the present invention. In the system of FIG. 1 the projection module (104) carries out such optimization by projecting, based on a projection algorithm (110), a performance forecast for a period of time. Such a period of time may be, for example, an upcoming quarter, a number of months (such as the holiday shopping season), and a number of days immediately following the launch of a new product, and so on.

A projection algorithm as the term is used in this specification is process by which a performance forecast is generated. Such a projection algorithm may be implemented as a module of computer program instructions, such as a function. The projection module (104) may pass such a function one or more arguments such as, for example, a time period for the forecast. The projection algorithm (110) in the example of

FIG. 1 includes a plurality of inputs (112) with each input (112) having a weight (114). An “input” as the term is used in this specification refers to data from a data source (120). Examples of data sources include social media services, direct customer feedback, indirect customer feedback, and web-based publications.

Social media services, like Twitter™ and Facebook™, may be data mined for keywords, phrases, or other data that may be used by the projection algorithm to infer various changes in the forecast. Consider, for example, a projection algorithm configured to generate a sales forecast for a particular product. The projection algorithm may indicate a higher forecast (greater number of sales) if many users of a social media service have posted positive reviews of the product, positive sentiment toward the product, positive sentiment toward the business itself, or a desire to purchase such product.

Direct customer feedback may include any feedback provided directly to the business.

Examples of such feedback may be customer service call statistics, customer service survey results, customer service email statistics and content, reviews of products provided directly to the business via a web interface or web form submission, data representing a user's ‘wish list’ on the business's e-commerce website, and so on.

Indirect customer feedback may include customer feedback regarding the business or a business's product(s) not provided directly to the user, but rather through other web-based media. Examples of such indirect customer feedback may include user reviews of a business's product on e-commerce sites other than business's e-commerce site.

Web-based publications may include any web-based data source not previously mentioned. Examples of such publications may include product review websites, news related websites, websites providing weather information, and the like. Consider, for example, that a major portion of a business's supply chain relies on products sources from Japan. Weather information indicating uncharacteristic but extremely harsh weather conditions in Japan may be utilized in the projection algorithm to generate a forecast that takes into account a possible loss of supply chain resources.

Each of these inputs may be weighted according to likelihood that inputs' data correlates to a change in the forecast. Consider, for example, that positive mentions of a business's product on a social media service may be less likely to indicate higher sales in the coming quarter than positive reviews provided directly to the company. In this way, such positive mentions on a social media site may be weighted less than positive reviews provided as direct customer feedback.

When establishing the algorithm, a set of inputs as well as a weight for each input may be provided by system administrator. As described below, the weights and inputs may be modified, automatically without the system administrator, as fine-tuning of the algorithm is carried out. The inputs described here are inputs from data sources not utilized by business analytics software of the prior art. It should be noted, however, that in addition to input described here, traditional data (such as past sales data) may also be utilized by the projection algorithm in projecting a performance forecast.

The projection algorithm (110) in the example of FIG. 1 is also associated with, or assigned, a confidence score (116). A confidence score (116) as the term is used in this specification is a value that represents the estimated accuracy of the algorithm to produce a performance forecast that reflects actual results.

After the projection module (104) of FIG. 1 projects a performance forecast (106), the projection module (106) may then capture results (108) of actual performance for the period of time. The projection module (106) may capture such results in a variety of ways including, receiving the results from a system administrator, data mining the business's sales databases, tracking business statistics in real or near real time and the like.

The projection module (104) in the example of FIG. 1 may then compare the results (108) of actual performance to the performance forecast (106). In doing so, the projection module (104) may determine whether the difference between the results of actual performance and the performance forecast is less than a predetermined threshold (118). The predetermined threshold represents an acceptable accuracy of the forecast to actual results. To that end, if the difference between the forecast and actual results is less than the predetermined threshold, the projection module (104) may increase the confidence score (116) associated with the projection algorithm.

Effectively, the projection algorithm produced a highly accurate forecast and, as such, the confidence score (116) representing the estimated accuracy of the algorithm to produce a forecast that reflects actual results is increased.

If, however, the difference between the results (108) and the performance forecast (106) is not less than the predetermined threshold (that is, the forecast does not reflect actual results with the desired accuracy), the projection module (104) optimizes the algorithm. The optimization may be carried out in iterative manner until a difference between the results of actual performance and a new forecast is less than the predetermined threshold. The steps carried out iteratively by the projection module may include modifying the projection algorithm, projecting a new forecast based on the modified projection algorithm and determining whether the difference between the results of actual performance and the new forecast is less than the predetermined threshold. Here, the projection module utilizes the actual results (108) recently captured to optimize the algorithm.

The projection module (104) may modify the projection algorithm (110) in a variety of ways. The projection module (104), for example, may modify one or more weights (114) of the inputs (112). The projection module (104) may also identify one or more additional inputs and assign a weight to each of the additional inputs. The projection module (104) may identify additional inputs in a variety of ways. One way, for example, is by data mining the original inputs for additional data sources. Consider, for example, an original input where the data source for the input is a news website. Consider also that the projection module may identify additional inputs as targets of hyperlinks on pages that included phrases that the algorithm utilized in projecting the performance forecast.

In another example, the projection module (104) may identify correlation between data in data sources and results from a set of actual performance results. That is, the projection module (104) may utilize historical results and data from data sources at the time of the results to identify additional inputs. Consider, for example, that a particular phrase was repeated in social media services in three of the last four quarters. In those three quarters, the actual performance results were positive. In the other quarter, where the particular phrase was not repeated in social media services, the actual performance results were poor. From this historical set of data, the projection algorithm (104) can identify, as an additional input to the projection algorithm, the presence of the particular phrase on social media services.

In this way, the projection algorithm takes into account data sources and inputs not utilized by business analytics software of the prior art when projecting a performance forecast. Further, the projection algorithm is continually optimized to provide more accurate forecasts.

Also stored in RAM (168) is an operating system (154). Operating systems useful optimizing a business performance forecast according to embodiments of the present invention include UNIX™ Linux™ Microsoft XP™ AIX™ IBM's i5/OS™ and others as will occur to those of skill in the art. The operating system (154), projection module (104), performance forecast (106), actual performance results (108), projection algorithm (110), confidence score (116), and predetermined threshold (118) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for optimizing a business performance forecast according to embodiments of the present invention include Integrated Drive Electronics ('IDE') adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for optimizing a business performance forecast according to embodiments of the present invention include modems for wired dial-up communications, Ethernet (IEEE 802.3) adapters for wired data communications, and 802.11 adapters for wireless data communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device

Transport Protocol), and others as will occur to those of skill in the art. Various embodiments of the present invention may be implemented on a variety of hardware platforms in addition to those illustrated in FIG. 1.

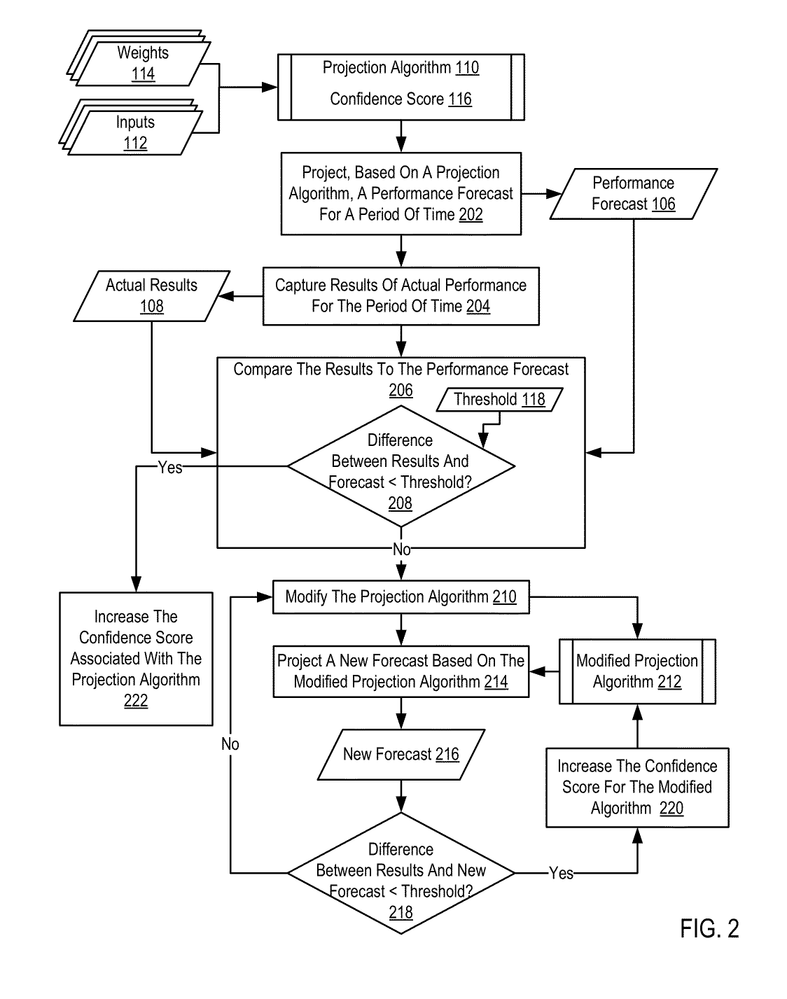

For further explanation, FIG. 2 sets forth a flow chart illustrating an exemplary method for optimizing a business performance forecast according to embodiments of the present invention. The method of FIG. 2 may be carried out by a projection module such as the projection module (104) depicted in the example of FIG. 1. The method of FIG. 2 includes projecting (202), by a projection module based on a projection algorithm (110), a performance forecast (106) for a period of time. Projecting (202) a performance forecast (106) may be carried out by providing, to the projection algorithm, one or more arguments, such as the period of time for which the forecast is to be projected, and receiving the forecast as a result of the algorithm's execution.

In the method of FIG. 2, the projection algorithm (110) includes a plurality of inputs (112) with each input having a weight (114). The projection algorithm (110) of FIG. 2 is also associated with a confidence score (116).

The method of FIG. 2 also includes capturing (204), by the projection module, results (108) of actual performance for the period of time. Capturing (204) results (108) of actual performance may be carried out in a variety of ways including, for example, by receiving the results from a system administrator, data mining the business's sales databases, tracking business statistics in real or near real time and the like.

The method of FIG. 2 also includes comparing (206), by the projection module, the results of actual performance to the performance forecast. In the example of FIG. 2, comparing (206) the results (108) of actual performance to the performance forecast (106) is carried out by determining (208) whether the difference between the results (108) of actual performance and the performance forecast (106) is less than a predetermined threshold (118).

If the difference between the results (108) and the performance forecast (106) is less than the predetermined threshold (118), the method of FIG. 2 continues by increasing (222), by the projection module, the confidence score (116) associated with the projection algorithm (110). If, however, the difference between the results (108) and the performance forecast (106) is not less than the predetermined threshold (118), then the method of FIG. 2 continues by modifying (210), by the projection module, the projection algorithm (212). The method of FIG. 2 also includes projecting (214), by the projection module, a new forecast (216) based on the modified projection algorithm (212) and determining (218), by the projection module, whether the difference between the results (108) of actual performance and the new forecast (216) is less than the predetermined threshold (118).

If the difference between the results (108) of actual performance and the new forecast (216) is less than the predetermined threshold (118), the method of FIG. 2 continues by increasing (220) the confidence score (116) for the modified algorithm (212). It is noted that the modified algorithm replaces the original projection algorithm (110) upon modification and the confidence score for the modified algorithm (212) is the confidence score (116) for the original projection algorithm (110) only updated to reflect successful optimization.

If the difference between the results of actual performance and the new forecast is not less than the predetermined threshold (118), the method of FIG. 2 returns to modifying (210) the projection algorithm (210), projecting (214) a new forecast (216), and determining (218) whether the difference between the results of actual performance and the new forecast is less than the predetermined threshold. In this way the steps of modifying (210), projecting (214) and determining (218) are carried out iteratively, until a difference between the results of actual performance and a new forecast is less than the predetermined threshold.

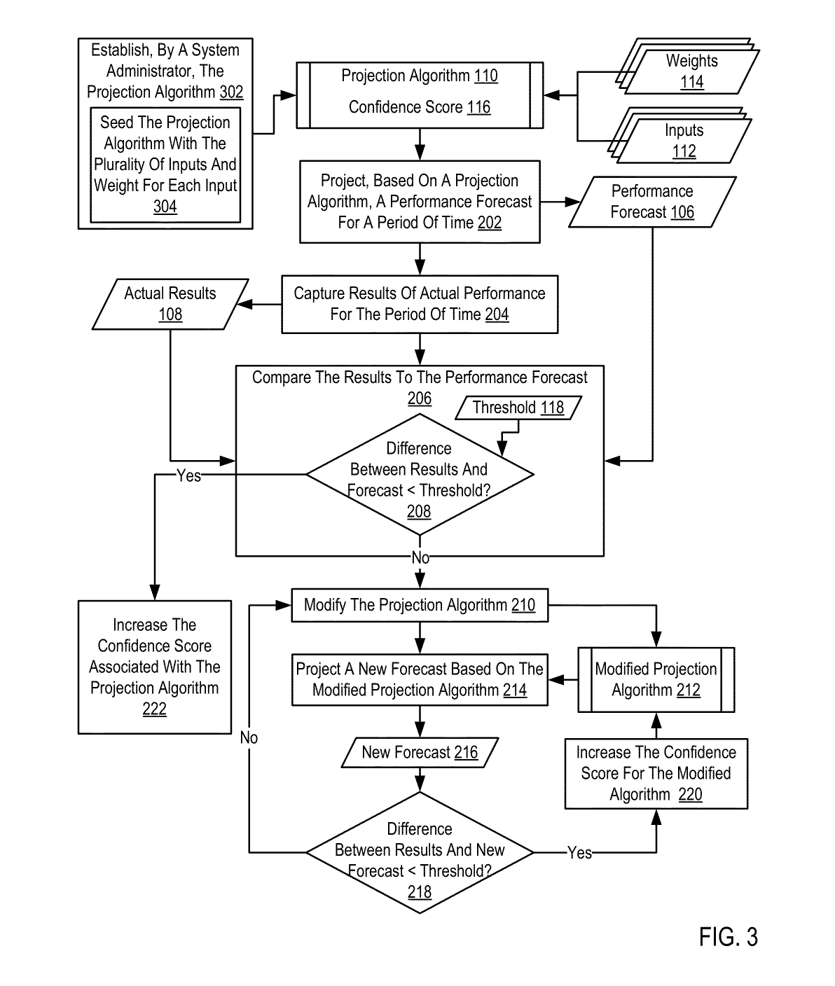

FIG. 3 sets forth a flow chart illustrating another exemplary method for optimizing a business performance forecast according to embodiments of the present invention. The method of FIG. 3 is similar to the method of FIG. 2 in that the method of FIG. 3 includes: projecting (202) a performance forecast for a period of time based on a projection algorithm; capturing (204) results of actual performance for the period of time; comparing (206) the results of actual performance to the performance forecast, including determining (208) whether the difference between the results and the forecast is less than a predetermined threshold; if so, increasing (222) the confidence score associated with the projection algorithm; and if not, iteratively, until a difference between the results of actual performance and a new forecast is less than the predetermined threshold: modifying (210) the projection algorithm; projecting (214) a new forecast; and determining (218) whether the difference between the results and the new forecast is less than the predetermined threshold.

The method of FIG. 3 differs from the method of FIG. 2, however, in that the method of FIG. 3 includes establishing (302), by a system administrator, the projection algorithm (110). In the method of FIG. 3, establishing (302) the projection algorithm (110) is carried out by seeding (304) the projection algorithm (110) with the plurality of inputs (112) and weight (114) for each input. The system administrator may establish the algorithm (110) with an educated guess, based on historical knowledge or empirical study, as to what data sources and inputs from those data sources may effect an accurate performance forecast. The system administrator may also make an educated guess as to the value of weight to assign to each input. Over time, as described above, additional inputs may be identified, and weights may be modified so as to provide more accurate forecasts. Such optimization may be carried out automatically without a user or system administrator's involvement.

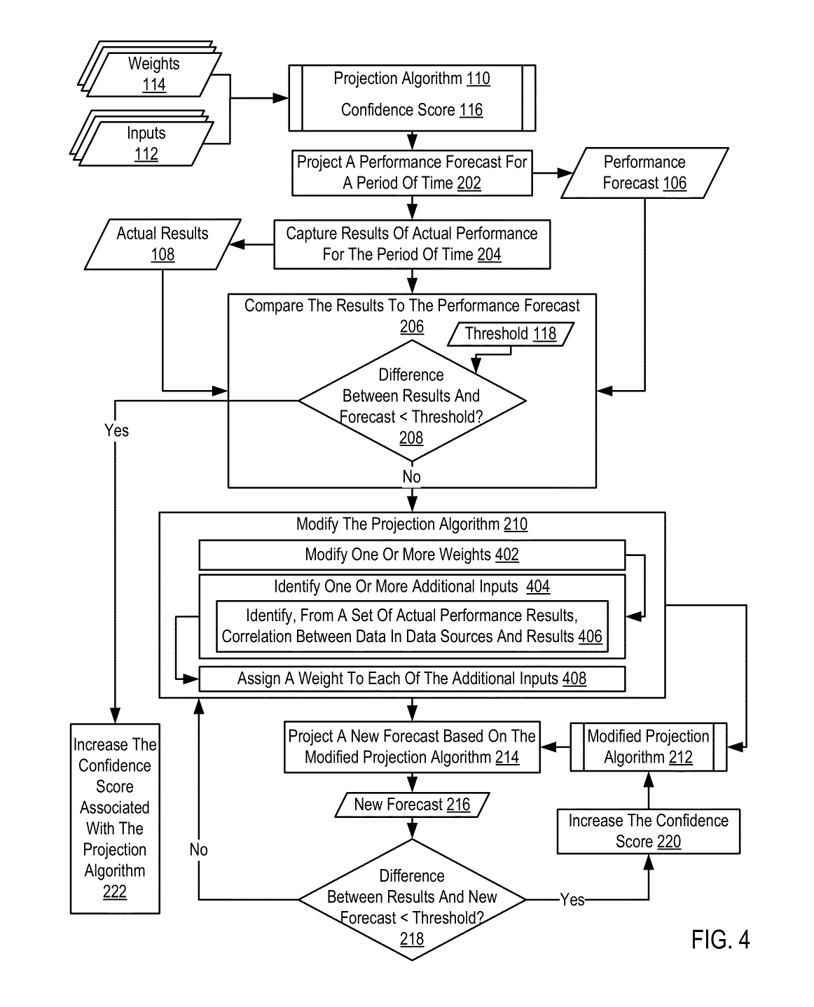

FIG. 4 sets forth a flow chart illustrating another exemplary method for optimizing a business performance forecast according to embodiments of the present invention. The method of FIG. 4 is similar to the method of FIG. 2 in that the method of

FIG. 4 includes: projecting (202) a performance forecast for a period of time based on a projection algorithm; capturing (204) results of actual performance for the period of time; comparing (206) the results of actual performance to the performance forecast, including determining (208) whether the difference between the results and the forecast is less than a predetermined threshold; if so, increasing (222) the confidence score associated with the projection algorithm; and if not, iteratively, until a difference between the results of actual performance and a new forecast is less than the predetermined threshold: modifying (210) the projection algorithm; projecting (214) a new forecast; and determining (218) whether the difference between the results and the new forecast is less than the predetermined threshold.

The method of FIG. 4 differs from the method of FIG. 2, however, in that in the method of FIG. 4, modifying (210) the projection algorithm includes modifying (402) one or more weights (114) of one or more of the plurality of inputs (112). Modifying (402) one or more weights (114) may be carried out in a variety of ways. For example, the projection module may reduce the weights of inputs (112) having the greatest impact on the forecast, the projection module may increase the weights of inputs (112) having the least impact on the forecast, the projection module may set a weight to zero, effectively removing the input altogether, or in other ways and in any combination.

Modifying (210) the projection algorithm in the example of FIG. 4 also includes identifying (404) one or more additional inputs and assigning (408) a weight to each of the one or more additional inputs. In the example of FIG. 4, identifying (404) additional inputs is carried out by identifying, from a set of actual performance results, correlation between data in data sources and results. Assigning (408) a weight to each of the additional inputs may be carried out in a variety of ways including assigning a default value for each weight, assigning a weight based on a number of unique instances of the input in the historical set of actual performance results, and in other ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of optimizing a business performance forecast, the method comprising:
projecting, by a projection module based on a projection algorithm, a performance forecast for a period of time, wherein the projection algorithm comprises a plurality of inputs with each input having a weight and the projection algorithm is associated with a confidence score;
capturing, by the projection module, results of actual performance for the period of time;
comparing, by the projection module, the results of actual performance to the performance forecast, including determining whether the difference between the results of actual performance and the performance forecast is less than a predetermined threshold;
if the difference between the results and the performance forecast is less than the predetermined threshold, increasing, by the projection module, the confidence score associated with the projection algorithm;
if the difference between the results and the performance forecast is not less than the predetermined threshold:
iteratively, until a difference between the results of actual performance and a new forecast is less than the predetermined threshold:
modifying, by the projection module, the projection algorithm;
projecting, by the projection module, a new forecast based on the modified projection algorithm; and
determining, by the projection module, whether the difference between the results of actual performance and the new forecast is less than the predetermined threshold.

2. The method of claim 1 further comprising increasing the confidence score for the modified algorithm after the difference between the results of actual performance and a new forecast is less than the predetermined threshold.

3. The method of claim 1 further comprising establishing, by a system administrator, the projection algorithm including seeding the projection algorithm with the plurality of inputs and weight for each input.

4. The method of claim 1 wherein modifying, by the projection module, the projection algorithm further comprises modifying one or more weights of one or more of the plurality of inputs.

5. The method of claim 1 further comprising modifying the projection algorithm further comprises identifying one or more additional inputs and assigning a weight to each of the one or more additional inputs.

6. The method of claim 4, wherein identifying one or more additional inputs further comprises identifying, from a set of actual performance results, correlation between data in data sources and results.

7. The method of claim 1 wherein each of the plurality of inputs comprises data from a data source and the data source may be any one of:
a social media service;
direct customer feedback;
indirect customer feedback; and
web-based publications.

8-20. (canceled)
